(19) United States
(12) Patent Application Publication
(10) Pub. No.: US 2014/0266689 A1
(43) Pub. Date: Sep. 18, 2014

(54) EVENT DETECTION AND REPORTING USING A GENERAL PURPOSE PROCESSOR AND A HARDENED PROCESSOR

(71) Applicant: SAFERAGING, INC., Reston, VA (US)

(72) Inventors: John McKINLEY, Great Falls, VA (US); Christopher WILLIAMS, Herndon, VA (US)

(21) Appl. No.: 13/840,181

(22) Filed: Mar. 15, 2013

(51) Int. Cl. G08B 23/00

(52) U.S. Cl. CPC G08B 23/00
USPC 340/539.1

(57) ABSTRACT

A system and method for detecting and reporting events in an emergency assistance system is provided. A general purpose processor can be configured to detect and report events to a remotely located emergency assistance system using at least a main radio to transmit information regarding the events. Also, a hardened processor can be configured to detect and report at least a subset of the events. The hardened processor can be used to report at least one event based at least in part on determining that the general purpose processor is unable to report the at least one event.

### CROSS-REFERENCE TO RELATED APPLICATIONS

This application relates to co-pending U.S. patent application Ser. No. ______, entitled “MULTIPLE-RADIO PENDANTS IN EMERGENCY ASSISTANCE SYSTEMS,” filed Mar. 15, 2013, co-pending U.S. patent application Ser. No. ______, entitled “AUTOMATED EVENT SEVERITY DETERMINATION IN AN EMERGENCY ASSISTANCE SYSTEM,” filed Mar. 15, 2013, co-pending U.S. patent application Ser. No. ______, entitled “DYNAMIC PROVISIONING OF PENDANT LOGIC IN EMERGENCY ASSISTANCE SYSTEMS,” filed Mar. 15, 2013, and co-pending U.S. patent application Ser. No. ______, entitled “HIGH RELIABILITY ALERT DELIVERY USING WEB-BASED INTERFACES,” filed Mar. 15, 2013, all of which are assigned to the assignee hereof, and the entireties of which are herein incorporated by reference for all purposes.

### BACKGROUND

Emergency assistance systems typically include one or more wearable pendants or wall-mounted devices that allow a user to indicate an emergency by pushing a button on a wearable pendant or a wall-mounted device. The wearable pendant or wall mounted device can communicate a button push event with an event detecting system. The event detecting system can forward the event and/or related information, such as an identifier or location of the event detecting system, to a centralized station for determining whether to dispatch assistance. The event detecting system, or one or more devices coupled thereto, can allow for audio communication between the centralized station and the site via telephone line to attempt voice communication with the person that pressed the button (e.g., to determine whether assistance is desired).

Advances in technology have enabled emergency assistance systems that allow for communications between the on-site event detecting system and one or more pendants, including voice communications, over more current wireless network technologies, such as WiFi. In addition, the event detecting systems can communicate with the centralized station over one or more packet-based networks. Pendant functionality, however, is typically limited to simple functionality of detecting button pushes and allowing audio communications. Thus, the logic for performing these tasks is typically implemented as static firmware in a hardened processor dedicated to performing these functions.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to providing a device installed at a site for monitoring by an emergency assistance system that utilizes a general purpose processor, or other computing device, to provide robust event detection and reporting functionality. The device can additionally include a hardened processor capable of performing certain critical functions implemented in its firmware. For example, this can be beneficial in situations where the general purpose processor is not available or otherwise not functioning properly. In this regard, for example, upon detecting an event on the device, if it is determined that the general purpose processor is unable to process the event, the hardened processor may be able to process the event using its incorporated logic, and accordingly report the event in an emergency assistance system to ensure the event is handled and alerting of the event is attempted.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIG. 1 is an aspect of an example system for detecting and reporting events in an emergency assistance system.

FIG. 2 is an aspect of an example system for providing contingent event detection and reporting.

FIG. 3 is an aspect of an example pendant employing multiple processors to possibly detect and report events.

FIG. 4 is an aspect of an example pendant employing multiple processors and hardware arbitration in detecting and reporting events.

FIG. 5 is an aspect of example systems for utilizing one of multiple processors to detect and/or report events.

FIG. 6 is an aspect of an example system for using multiple processors for contingent event detection and reporting.

FIG. 7 is an aspect of an example methodology for determining whether a general purpose processor is able to report a detected event.

FIG. 8 is an aspect of an example system in accordance with aspects described herein.

FIG. 9 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to a device in an emergency assistance system, such as a wearable pendant, a wall-mounted device, or other devices that facilitate detecting and/or reporting events in an emergency assistance system. For example, wearable pendants can include various form factors, such as a pendant with a lanyard for wearing around the neck, a watch form factor for wearing on a wrist (e.g., where the watch can function as a watch and also include the pendant or components thereof), etc. As described herein, the pendants, wall-mounted devices, etc., can use a general purpose processor to provide robust event detection and reporting functionality, as well as a hardened processor to provide a subset of critical event detection and reporting functionality. In this regard, where the general purpose processor is not functioning properly, the hardened processor can be used to detect and report at least a subset of events related to the device. The device can include a switch to allow hardware arbitrated access between the processors and one or more components of the device to ensure only one of the processors is used to detect and report a given event. Thus, in one example, the hardened processor can determine that the general purpose processor is unable to report an event, and can accordingly switch the switch to allow hardened processor to utilize one or more components of the device to detect and/or report events. In one example, the device can report switching of the switch to an emergency assistance system to notify that the general purpose processor is not functioning properly. In another example, the device uses the hardened processor until the general purpose processor is again functioning properly.

As used in this application, the terms “component,” “module,” “system,” “device” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for operating an event detecting device of an emergency assistance system. System 100 includes an event detecting device 102 for detecting occurrence of one or more events based on one or more measured parameters. The event detecting device 102 can communicate event information over a network 104 to an event processing component 106, in one example, to report the event. An alerting component 108 can be provided as well to generate one or more alerts to one or more devices based on the detected event. For instance, where the components 102, 106, and 108 relate to an emergency assistance system, event detecting device 102 can be a wearable pendant, a wall-mounted device, or other mechanism deployed to detect one or more events related to a person at the site of deployment (e.g., in a home of the person, in an assisted-living facility at which the person is resident, etc.). Event processing component 106 processes events reported by the event detecting device 102 and determines whether to send one or more alerts related to the events using alerting component 108, such as an alert to a monitoring station at or near where the event detecting device 102 is deployed, an alert to emergency dispatch services, and/or the like.

Network 104 can include a collection of nodes communicatively coupled with one another via one or more components (e.g., switches, routers, bridges, gateways, etc.), which can include, or can include access to, an Internet, intranet, etc. In addition, in an example, event processing component 106, alerting component 108, logic provisioning component 110, etc., can each be, or can collectively include, one or more servers purposed with performing at least a portion of the described functionalities. Thus, in one example, one or more of the components 106, 108, or 110 can be distributed among multiple servers within network 104 in a cloud computing environment.

System 100 can optionally include an event detecting system 116 that can communicate with multiple event detecting devices installed at a site, and may function as a gateway facilitating communicating between the event detecting devices and network 104. Thus, event detecting system 116 can communicate with event processing component 106 via network 104 to provide information regarding events detected by the various event detecting devices at the site. Event detecting system 116 is accordingly coupled to network 104. This can include a wireless coupling, such as a WiFi connection to network 104 via a router or other network component, a cellular connection to network 104, etc., a wired coupling, such as over a local area network (LAN), and/or the like. Event detecting device 102 may communicate with event detecting system 116 using its secondary radio (e.g., as a backup mechanism for communicating), and/or using its main radio, as described further herein.

Event detecting device 102 can utilize a general purpose processor 112 to execute robust event detection and reporting logic. In one example, the logic can be updatable by logic provisioning component 110. Examples of robust event detection and reporting include logic for detecting falls via the event detecting device 102 by using an incorporated accelerometer, digital barometer, and/or the like, detecting inactivity over a period of time, detecting drastic ambient temperature changes, and/or the like. General purpose processor 112 can thus be configured to detect and report such events to event processing component 106 (e.g., by using an integrated radio to access network 104 or a component having access thereto, such as an on-site event detecting system 116). Event detecting component also includes a hardened processor 114 configured with static firmware to perform at least a subset of the event detecting and reporting functionality additionally or alternatively to the general purpose processor 112. In this regard, where the general purpose processor 112 is not functioning properly or is otherwise unable to detect and/or report a certain critical event, which may be caused due to errors in provisioned logic for example, the hardened processor 114 can ensure detecting and reporting of the event.

In one specific example, an emergency button push event on the event detecting device 102 can indicate a request for emergency assistance. Typically, general purpose processor 112 can detect the emergency button push and report the event to event processing component 106. If the general purpose processor 112 and/or a radio related thereto are not functioning properly, however, hardened processor 114 can also detect the emergency button push event, and can attempt to report the event to event processing component 106 over the same or a different radio (and/or can report the event to an on-site event detecting system 116 or render one or more local alarms). For example, employing a general purpose processor 112 can result in uncertainty regarding operability of the event detecting device 102 (e.g., where the application software is corrupt, contains memory leaks, etc.), especially where the application software is updateable. Thus, the hardened processor 114 can provide a contingent event detecting and reporting mechanism, at least for certain critical events for which logic is implemented in the static firmware, in the case where the general purpose processor 112 is not functioning such to detect and/or report the events.

FIG. 2 illustrates an example system 200 for detecting and reporting events in an emergency assistance system. System 200 includes an event detecting device 102 that communicates with a network 104 to report detected events, as described. Event detecting device 102 can be a wearable pendant, a wall-mounted switch, and/or other mechanism for detecting or otherwise triggering events in the emergency assistance system. In some examples, event detecting device 102 can communicate with network 104 through an on-site event detecting system that collects events from various event detecting components and provides a gateway to network 104 for reporting the events, though examples described herein are not so limited. System 200 also includes one or more components of an emergency assistance system, such as an event processing component 106, as described.

Event detecting device 102 can include a general purpose processor 112 for robust event detection and reporting, and a hardened processor 114 able to perform at least a subset of the event detection and reporting. General purpose processor 112 can accordingly include an event detecting component 202 for detecting one or more events based on measurements received from one or more components of the event detecting device 102, and an event reporting component 204 for reporting the one or more events over network 104 to an emergency assistance system. Hardened processor 114 includes a processor status component 206 for determining a status of the general purpose processor 112, an event detecting component 208 for detecting one or more events, which can be a subset of events that event detecting component 202 can detect, and an event reporting component 210 for reporting the events.

According to an example, general purpose processor 112 can execute logic to detect and report certain events. Event detecting device 102 can have various components to measure parameters indicative of the events (not shown). Event detecting component 202 of general purpose processor 112 can typically detect the events based at least in part on comparing parameter measurements to thresholds indicative of the events. Event reporting component 204 can report the events over network 104 using one or more radios of the event detecting device 102 to communicate with the network 104 (e.g., directly or through one or more gateways, such as a router, an on-site event detecting system, etc.).

In addition, hardened processor 114 is also capable of detecting and reporting at least a subset of events. In one example, event detecting component 208 of hardened processor 114 detects an event on event detecting device 102. In this example, processor status component 206 can determine a status of the general purpose processor 112 in determining whether to report the event. If processor status component 206 determines the general purpose processor 112 is in a favorable state such to report the event, event reporting component 210 of the hardened processor 114 may not report the event. If processor status component 206 determines the general purpose processor is in an unfavorable state, for example, hardened processor 114 can use event reporting component 210 to report the event. This can include reporting the event to the emergency assistance system over network 104 (e.g., using a radio to communicate with network 104 and/or a gateway thereto, such as a router, on-site event detecting system, etc.). In another example, event reporting component 210 can report the event to an on-site event detecting system (e.g., where there is no connection to the emergency assistance system via network 104 or otherwise), which can report the event to an external alarm or other device. In yet other examples, event reporting component 210 can report the event to the external alarm, can report the event by rendering local alarms (e.g., where there is no connection to the on-site event detecting system or otherwise), and/or the like.

In an example, processor status component 206 can query general purpose processor 112 for the status (e.g., periodically, based on one or more events, etc.), and/or can otherwise be notified of the status. For example, general purpose processor 112 can report periodic status event messages to event processing component 106 or another component of the emergency assistance system over network 104 indicating that it is in a favorable state. Where one or more consecutive status event messages are not received, the event processing component 106 can determine the general purpose processor 112 is in an unfavorable state, and can send a notification to hardened processor 114 indicating such. The indication can be received by the hardened processor 114 over a radio utilized by the hardened processor 114, which may or may not be the same radio used by general purpose processor 112. In another example, general purpose processor 112 can also indicate the periodic status event messages to hardened processor 114 or another component of event detecting device 102, such that the processor status component 206 can infer an unfavorable status for general purpose processor 112 based on not receiving one or more consecutive status events therefrom.

In a specific example, the subset of events that can be detected both by event detecting component 202 of general purpose processor 112 and event detecting component 208 of hardened processor 114, where both are functioning properly, can include critical events, such as a discrete emergency button push event. Thus, where such critical events are detected by both event detecting components 202 and 208, event reporting component 210 can report the critical events at least where processor status component 206 determines general purpose processor 112 is in an unfavorable state or otherwise cannot report the event (e.g., where a radio used by the general purpose processor 112 is not connected or is otherwise in an unfavorable state, etc.).

It is to be appreciated that including the hardened processor 114 in the event detecting device 102 can provide a contingent event delivery mechanism for certain critical events on the event detecting device 102. The hardened processor 114 can include static firmware compiled using a certified compiler for safety-critical embedded systems. Accordingly, the general purpose processor 112 can be provisioned with logic to perform various additional robust event detection and reporting functionalities while basic or critical functions of the event detecting device 102 (e.g., discrete emergency button push event detection and reporting) can occur in the event that provisioned logic failure (or other general failure) causes the general purpose processor 112 to be unable to report events.

Moreover, though the hardened processor 114 is shown as including the logic for processor status component 206, it is to be appreciated that this logic can be provided by other components of the event detecting device 102, as described in examples herein. Substantially any mechanism for determining the status and/or brokering which processor 112 or 114 has access to the components of the event detecting system can be defined and utilized.

FIG. 3 illustrates an example pendant 300 for operation in an emergency assistance system. Pendant 300 can include one or more of the various components depicted to facilitate event detection and reporting by the pendant 300. For example, pendant 300 can include a general purpose processor 112 and/or a hardened processor 114, as described, for detecting and reporting one or more events to an emergency assistance system. Pendant 300 also includes an emergency button 302 for indicating an emergency by activating the button 302. Pendant 300 additionally includes a switch 304 connected to the processors 112 and 114 and to one or more components, such as components 308, 312, 314, and 316, to allow one or the other processor to use the components.

Pendant 300 can include a main radio 308, such as a WiFi, cellular, Bluetooth, ZigBee, or similar radio to facilitate reporting events or other information to one or more components of an emergency assistance system, and a secondary radio 310 to additionally or alternatively communicate with one or more components of the emergency assistance system. For example, the secondary radio 310 can communicate using a different frequency spectrum, protocol or technology (e.g., 2.4 gigahertz (GHz)), etc. than the main radio 308. Pendant 300 can also include a speaker 312 to render audio tones or messages, which can be or can include a piezo buzzer, a microphone 314 to record audio, and a light emitting diode (LED) array 316, or similar illumination source, for displaying light for a detected event. Moreover, pendant 300 can include an accelerometer 320 to measure acceleration of the pendant 300, a digital barometer 322 to measure height change of the pendant 300, a thermometer 324 to measure ambient temperature, and a GPS receiver 326 to determine a GPS position of the pendant 300.

As depicted, general purpose processor 112 is coupled to main radio 306, accelerometer 320, digital barometer 322, thermometer 324, and GPS receiver 326 for providing robust event detection and reporting. Switch 304 allows general purpose processor 112 to also use secondary radio 308, speaker 312, microphone 314, and LED array 316 where the switch is appropriately positioned. Switch 304, however, can be positioned such to provide access of secondary radio 308, speaker 312, microphone 314, and LED array 316 to hardened processor 114 instead. Emergency button 302 can be connected to both processors 112 and 114 to allow for detecting events related to a discrete button push.

According to an example, when switch 304 is switched such to allow general purpose processor 112 to access the components 308, 312, 314, and 316, pendant 300 can provide robust event detection and reporting. For example, pendant 300 can operate according to one or more defined thresholds for measured parameters of the various components to facilitate detecting events, such as fall detection, inactivity monitoring, environmental monitoring, etc. In addition, pendant 300 can provide for local alarming, reminder playback, audio recording, and/or the like. In one specific example, the pendant 300 can specify parameter thresholds for fall detection, which can include detecting an acceleration measurement above a threshold via accelerometer 320 combined with a height adjustment measurement over a threshold via digital barometer 322. Where such is detected, main radio 306 and/or secondary radio 308 can attempt to communicate a fall detection event to the emergency assistance system. Additionally or alternatively, general purpose processor 112 can cause LED array 316 to flash, speaker 312 to sound a tone, and/or the like (e.g., where communication with the emergency assistance system fails, or otherwise).

In another specific example, the pendant 300 can specify parameters for activity/inactivity monitoring, which can include inferring activity based on accelerometer 320 measurements, measurements of position over time from GPS receiver 326, etc. Pendant 300 can define parameter thresholds for detecting events related to too much inactivity (which may indicate the person is in distress). The thresholds may vary for different profiles, during different times of day, etc. For example, a minimum threshold for acceleration measurements via accelerometer 320 may be lower midday than overnight, as the person may be assumed to be sleeping overnight. In addition, in an example, the pendant 300 can define parameter thresholds for allowed location of the pendant measured by GPS receiver 326 (e.g., to facilitate range fencing of a person where an event is triggered when the pendant is determined to be outside of an allowed location range). In yet another example, the pendant 300 can specify parameter thresholds for detecting events based on temperature according to measurements by thermometer 324, which can also be specific for a given pendant. Thus, a lower range of temperature can be acceptable as specified for a person who prefers to keep their house (or other site of emergency assistance system installation) cooler.

Moreover, the pendant 300 can define parameters for certain audio playback via speaker 312, such as a reminder to take medicine played at certain times of day. It is to be appreciated that the audio files can be included in the logic or otherwise obtained and stored in memory 306. In another example, the audio can be streamed (e.g., over the main radio 114) as specified in the logic. The delivery mechanism, content, and instructions for playing the audio can all be defined in logic, which may be provisioned to pendant 300, and executed using general purpose processor 112. In further examples, the logic can specify parameters related to event reporting, such as: an audio stream, volume, duration, etc. for sounding an alarm on speaker 312 for certain detected events; duration, intensity, pattern, color, etc. for flashing LEDs in LED array 316 for certain detected events; audio sampling duration for microphone 314 based on certain detected events; and/or the like. For instance, the audio sampling data from microphone 314 can be transmitted to the emergency assistance system for playback to personnel, automated triage to determine possible status of the person based on the audio sampling and other event data, etc.

Moreover, in an example, the pendant 300 can define parameter thresholds for detecting a lost pendant event; for example, this can include detecting that the pendant 300 has not moved location over a certain period of time via GPS receiver 326 measurements, detecting the pendant 300 has been in a low power state during this time, determining that the pendant 300 is not in radio range (e.g., no connection via main radio 306 or secondary radio 308), and/or the like. The pendant 300 can also define reporting for the lost pendant event (e.g., activate a tone over speaker 312, display lights on LED array 316, etc.). In additional examples, pendant 300 can communicate with other devices, such as a vital statistic monitoring device (e.g., a sphygmomanometer, pulse rate detector, internal thermometer, etc.) to detect and/or report events related thereto.

The above are examples of different pendant logic that can be utilized by pendant 300 and executed by general purpose processor 112. These examples are not intended to limit possible logic that can be defined for the components of a pendant 300 (e.g., and/or provisioned to the pendant 300). In addition, in some examples, logic utilized by the general purpose processor 112 can be downloadable from one or more components of the emergency assistance system such that pendant 300 can execute dynamic logic via the general purpose processor 112. Moreover, in an example, the logic can be context specific such that changes detected in a context or environment related to a person can result in generation and transmission of new logic provisioned to pendant 300. Also, in one specific example, main radio 306 can be an electric imp WiFi radio, which can include general purpose processor 112. Secondary radio 308 can be of another wireless technology, such as IEEE 802.15.4 standards (˜900 Mhz), to facilitate providing an alternative communication solution where main radio 306 (and/or its integrated processor 112) fails.

In some examples, switch 304 can be switched to allow hardened processor 114 access to components 308, 312, 314, and 316 (e.g., instead of general purpose processor 112). For example, switch 304 can be switched where hardened processor 114, or another component of pendant 300, determines that the general purpose processor 112 is not functioning properly, or otherwise cannot report a detected event. When switch 304 is switched, hardened processor 114 can detect events, such as a push of emergency button 302, and can report the event via secondary radio 308 to the emergency assistance system, to an on-site event detecting system, to an external alarm for notifying on-site personnel of the event, and/or the like. In addition, in an example, hardened processor 114 can utilize speaker 312 and LED array 316 to render the event on the pendant 300 (and/or microphone 314 to record audio related to the event). In this regard, hardened processor 114 can include static firmware compiled with a certified compiler to perform detecting and reporting of the emergency button 302 push event to ensure the functionality for reporting such a critical event even where general purpose processor 112 is not functioning or is otherwise inhibited from reporting the event.

In one example, switch 304 can be a solenoid switch or similar switch that can allow one of two or more alternative communication paths to pass between the switch and various components (e.g., components 308, 312, 314, and 316). Thus, in this example, hardware arbitrated access is allowed to the components 308, 312, 314, and 316 by either general purpose processor 112 or hardened processor 114. Hardware arbitrated access to various ones of the components can be provided using a number of configurations based on a received, inquired, or otherwise determined status of the general purpose processor 112; a few are described herein as examples. In a specific example, general purpose processor 112 and hardened processor 114 can typically detect a push event at emergency button 302. Based on detecting the event, hardened processor 114 can determine whether general purpose processor 112 is functioning properly and/or can otherwise process the event. If not, hardened processor 114 can cause switching of the switch 304 (e.g., by sending a command thereto or to an associated controller) to facilitate accessing one or more of components 308, 312, 314, and 316 to report the event and/or perform related operations. If hardened processor 114 determines the general purpose processor 112 is functioning properly, however, hardened processor 114 can cease from reporting the event (and can cease from switching the switch 304).

It is to be appreciated that once switch 304 is switched to communicate with hardened processor 114, hardened processor 114 is used to detect and report events for which it is programmed to do so. Switch 304 can be switched back based on hardened processor 114 determining that the general purpose processor 112 has become operational, based on the general purpose processor 112 causing switching of the switch 304 upon becoming operational, based on a factory reset of the pendant 300 (and thus the switch 304), and/or the like. Moreover, it is to be appreciated that other components, in addition or alternatively to emergency button 302, can be connected to both processors 112 and 114 outside of the switch 304 as well, such as accelerometer 320. This can allow for detection of additional events by hardened processor where general purpose processor 112 is not able to process such events, etc.

In addition, though shown as caused based on activation of the emergency button 302, it is to be appreciated that hardened processor 114 can switch the switch 304 based on other events detectable by the hardened processor 114. Moreover, for example, hardened processor 114 can switch the switch 304 based on receiving an indication from the emergency assistance system that the general purpose processor 112 is not functioning properly (e.g., or an explicit command from the emergency assistance system to switch the switch 304). In another example, hardened processor 114 can periodically query the general purpose processor 112, and can switch the switch 304 based at least in part on receiving an unfavorable result to the query (or no result to one or more consecutive queries after a period of time, etc.). Other events can cause hardened processor 114 to switch the switch 304 and take over event detecting and reporting. For example, this can include a detected change in location of the pendant 300 to a location with no access for main radio 306 to communicate with the emergency assistance system, a detected loss of connection by main radio 306, failure of other ones of the components 306, 308, 312, 314, 316, 320, 322, 324, and/or 326, etc.

FIG. 4 illustrates an example pendant 400 for operation in an emergency assistance system. Pendant 400 can include one or more of the various components depicted to facilitate event detection and reporting by the pendant 400. For example, pendant 400 can include a general purpose processor 112 and/or a hardened processor 114, as described, for detecting and reporting one or more events to an emergency assistance system. Pendant 400 also includes an emergency button 302 for indicating an emergency by activating the button 302. Pendant 400 additionally includes a hardware arbitration component 402 connected to the processors 112 and 114 and to one or more components, such as components 302, 308, 312, and 316, to allow one or the other processor to use the components.

General purpose processor 112 can be an IMP or similar device that includes a main radio 308, such as a WiFi, cellular, Bluetooth, ZigBee, or similar radio to facilitate reporting events or other information to one or more components of an emergency assistance system. Pendant 400 additionally includes a secondary radio 310 to additionally or alternatively communicate with one or more components of the emergency assistance system. Pendant 400 can also include a speaker 312 to render audio tones or messages, a microphone 314 to record audio, and a light emitting diode (LED) array 316, or similar illumination source, for displaying light for a detected event. Moreover, pendant 400 can include an accelerometer 320 to measure acceleration of the pendant 300, a digital barometer 322 to measure height change of the pendant 300, a thermometer 324 to measure ambient temperature, and a GPS receiver 326 to determine a GPS position of the pendant 400.

As depicted, general purpose processor 112 is coupled to microphone 314, accelerometer 320, digital barometer 322, thermometer 324, and GPS receiver 326 for providing robust event detection and reporting. Hardware arbitration component 402 allows general purpose processor 112 to send and/or receive input/output signals or other control signals to emergency button 302, secondary radio 308, speaker 312, and LED array 316 so long as it receives a square wave from general purpose processor 112. Where hardware arbitration component 402 fails to receive the square wave from general purpose processor 112, which can indicate failure in the general purpose processor, hardware arbitration component 402 can instead allow hardened processor 114 to send and/or receive input/output signals or other control signals to emergency button 302, secondary radio 308, speaker 312, and LED array 316.

FIG. 5 illustrates example systems 500 and 502 for providing hardware arbitrated access of certain components of an event detecting device to one or more processors. System 500 represents a specific example of electronics for receiving a square wave as input from a processor (e.g., the IMP processor or other general purpose processor described herein). The electronics in system 500 output a control signal ARB_IMP_EN 504 based on whether the square wave is generated. The control signal 504 is provided, in this specific example, to the electronics in system 502. A hardware arbitration circuit 506, which can be an example of a hardware arbitration component described herein, can control which inputs/outputs are associated with certain components.

For example, as depicted, an input 508 from a photonic integrated circuit (PIC) (e.g., the hardened processor) for a first LED and an input 510 from the IMP (e.g., the general purpose processor) for the first LED can be arbitrated by the arbitration circuit 506 based on the control signal 504, such that one of the inputs 508 or 510 is associated with an associated output 512 to the first LED. Where the control signal 504 indicates that the square wave (e.g., the control signal is sent) is received from the IMP, the hardware arbitration circuit 506 selects the input 510 from the IMP for association with the output 512. If the control signal 504 is not sent, the hardware arbitration circuit 506 can associate input 508 with output 512, for example. It is to be appreciated that this is a specific example of performing hardware arbitration between processors based on a square wave generated by one of the processors. Substantially limitless hardware, software, etc. configurations can be similarly utilized in this regard to provide contingent processor utilization based on the health or status of one of the processors.

FIG. 6 illustrates an example system 600 for employing multiple processors for contingent detection and reporting of events. System 600 includes a general purpose processor 112 and hardened processor 114, as described above, which can operate in a pendant or other device of an emergency assistance system. An event 602 can occur, which is normally detectable by general purpose processor 112 and hardened processor 114, such as an emergency button push on a pendant. At 604, general purpose processor 112 may or may not detect the event depending on whether it is functioning properly. Hardened processor 114 can detect the event at 606, and can send a status request 608 to the general purpose processor 112. Hardened processor 114 may or may not receive a status response 610 from general purpose processor 112.

If no response is received after a threshold period of time, hardened processor can switch the solenoid switch at 612 and/or report the event at 614. In this regard, hardened processor 114 can detect and report future events due to switching the solenoid. Similarly, if a status response 610 is received from the general purpose processor 112, but indicates the general purpose processor 112 is unable to report the event (e.g., a main radio failure, the general purpose processor lacks sufficient resources, etc.), hardened processor 114 can switch the solenoid at 612 and/or report the event at 614. It is to be appreciated that where the status response 610 indicates the general purpose processor 112 currently lacks sufficient resources to report the event, hardened processor may not switch the solenoid at 612 so general purpose processor 112 can attempt to report subsequent events. If a favorable status response 610 is received, hardened processor 114 can refrain from switching the solenoid and from reporting the event, and can allow general purpose processor 112 to report the event at 616.

Referring to FIG. 7, a methodology that can be utilized in accordance with various aspects described herein is illustrated. While, for purposes of simplicity of explanation, the methodology is shown and described as a series of acts, it is to be understood and appreciated that the methodology is not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 7 illustrates an example methodology 700 for detecting and reporting events in an emergency assistance system. At 702, an event can be detected based on one or more parameters from a component. For example, this can include detecting a critical event via a hardened processor, such as a discrete emergency button push, or other event for which detection logic is coded into the firmware of the hardened processor. At 704, it can be determined whether a general purpose processor is able to report the event. For example, this can include querying the general purpose processor for a status and determining whether the general purpose processor is able to report the event based on a response to the query, based on whether a response to the query is received within a threshold period of time, based on whether responses to additional queries are received, etc. In another example, determining whether the general purpose processor is able to report the event at 704 can be based on at least one of an indication received from an emergency assistance system that the general purpose processor failed to report one or more consecutive status event messages thereto, a inference that the general purpose processor failed to report the one or more consecutive status event messages, a determination that the general purpose processor failed to report one or more consecutive local messages, and/or the like.

If the general purpose processor is able to report the event at 704, the methodology 700 ends, and the general purpose processor is allowed to handle the reporting. If, however, the general purpose processor is unable to report the event at 704, a solenoid switch can optionally be switched at 706 to allow access to pendant components. As described, the switching can allow access to various pendant components that facilitate event reporting, such as a secondary radio for communicating with an on-site event detecting system, one or more local alarm rendering components, such as a speaker, LED array, etc., and/or the like. At 708, the switching of the switch is optionally reported over the secondary radio of the pendant. Thus, the emergency assistance system can be informed of the processor switch, and can notify a component of the system of the switch (e.g., which can indicate that the related device may need technical assistance). In this regard, the pendant can be replaced or repaired based on the notification. At 710, the event is reported using the pendant components. As described, this can include reporting the event via the secondary radio to the emergency assistance system, an on-site event detecting system, one or more external alarms, etc. In addition, reporting the event at 710 can include rendering one or more local alarms, as described.

To provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., cathode ray tube (CRT), liquid crystal display (LCD), light emitting diode (LCD), plasma . . . ), speakers, printers and other computers, among other things.

According to an example, computer 812 can perform the general purpose processor functions, as described. In this example, the processing unit(s) 814 can comprise or receive instructions related to event detection and reporting, receiving and executing provisioned logic, etc., and/or other aspects described herein. It is to be appreciated that the system memory 816 can additionally or alternatively house such instructions and the processing unit(s) 814 can be utilized to process the instructions.

FIG. 9 is a schematic block diagram of a sample-computing environment 900 with which the subject innovation can interact. The environment 900 includes one or more client(s) 910. The client(s) 910 can be hardware and/or software (e.g., threads, processes, computing devices). The environment 900 also includes one or more server(s) 930. Thus, environment 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The environment 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can be pendants or other event detecting devices that report events to server(s) 930 via communication framework 950. The one or more clients 910 may employ contingent processing logic, as described, to detect and report the events over communication framework 950, as described herein.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for detecting and reporting events in an emergency assistance system, comprising:
a general purpose processor configured to detect and report events to a remotely located emergency assistance system using at least a main radio to transmit information regarding the events; and
a hardened processor configured to detect and report at least a subset of the events, wherein the hardened processor is used to report at least one event based at least in part on a determination that the general purpose processor is unable to report the at least one event.

2. The system of claim 1, further comprising a hardware arbitration component that allows the hardened processor or the general purpose processor hardware arbitrated access to components for detecting and reporting the events.

3. The system of claim 2, wherein the hardware arbitration component determines to allow the hardened processor arbitrated access to the components based on detecting that a square wave is no longer received from the general purpose processor.

4. The system of claim 3, wherein the components include a secondary radio, and the hardened processor utilizes the secondary radio to communicate an event related to switching the switch to the emergency assistance system.

5. The system of claim 3, wherein the components include a main radio, and the hardened processor utilizes the main radio to communicate an event related to switching the switch to the emergency assistance system.

6. The system of claim 3, wherein the components include a secondary radio, and the hardened processor utilizes the secondary radio to transmit information regarding the at least one event.

7. The system of claim 3, wherein the components include one or more alarm components, and the hardware arbitration component causes the hardened processor to utilize the one or more alarm components to render a local alarm in reporting the at least one event.

8. The system of claim 1, further comprising a switch that allows hardware arbitrated access to components for detecting and reporting the events, wherein the hardened processor switches the switch to access the components based at least in part on determining that the general purpose processor is unable to report the at least one event.

9. The system of claim 1, further comprising an emergency button for indicating an emergency event, wherein the general purpose processor and the hardened processor are configured to detect activation of the emergency button indicating the emergency event.

10. The system of claim 9, wherein the at least one event is the emergency event indicated by the emergency button, and further comprising a hardware arbitration component configured to determine whether the general purpose processor is able to report the at least one event based at least in part on detecting activation of the emergency button indicating the emergency event.

11. The system of claim 10, wherein the hardware arbitration component causes the hardened processor to utilize a secondary radio to communicate the emergency event with an on-site event detection system or the emergency assistance system where the hardware arbitration component determines that the general purpose processor is unable to report the emergency event.

12. The system of claim 10, wherein the hardware arbitration component causes the hardened processor to utilize a main radio to communicate the emergency event with an on-site event detection system or the emergency assistance system where the hardware arbitration component determines that the general purpose processor is unable to report the emergency event.

13. The system of claim 10, wherein the hardware arbitration component causes the hardened processor to render one or more local alarms where the hardened processor determines that the general purpose processor is unable to report the emergency event.

14. The system of claim 1, wherein the hardened processor determines that the general purpose processor is unable to report the at least one event based at least in part on failure of the general purpose processor to report one or more consecutive status events.

15. The system of claim 14, wherein the hardened processor receives an indication of the failure of the general purpose processor to report the one or more consecutive status events from the emergency assistance system.

16. The system of claim 1, wherein the hardened processor comprises static firmware compiled using a certified compiler.

17. A method for detecting and reporting events in an emergency assistance system, comprising:
detecting an event using a hardened processor based on one or more parameters received from a component;
determining whether a general purpose processor is able to report the event; and
reporting the event using the hardened processor where it is determined that the general purpose processor is not able to report the event.

18. The method of claim 17, wherein the determining whether the general purpose processor is able to report the event is based at least in part on determining whether a square wave is received from the general purpose processor.

19. The method of claim 17, wherein the reporting the event comprises transmitting information regarding the event to an emergency assistance system using a secondary radio.

20. The method of claim 17, wherein the reporting the event comprises transmitting information regarding the event to an on-site event detecting system using a main radio.

21. The method of claim 17, wherein the reporting the event comprises rendering one or more local alarms.

22. The method of claim 17, wherein the event corresponds to a discrete button push event of an emergency button.

23. The method of claim 17, further comprising receiving an indication that the general purpose processor failed to transmit one or more consecutive status reports, wherein the determining whether the general purpose processor is able to report the event is based at least in part on the indication.
